(19) United States
(12) Patent Application Publication
(10) Pub. No.: US 2014/0320313 A1
(43) Pub. Date: Oct. 30, 2014

(54) SYSTEM AND METHOD FOR SUPPLYING POWER TO TRANSMISSION TOWER USING OPTICAL POWER TRANSMISSION DEVICE AND METHOD FOR TRANSMITTING AND RECEIVING DATA USING THE OPTICAL POWER TRANSMISSION DEVICE

(71) Applicant: KHVATEC Co., Ltd., Gumi-si (KR)

(72) Inventor: Ul Lok BAE, Sungnam-si (KR)

(21) Appl. No.: 13/922,603

(22) Filed: Jun. 20, 2013

(30) Foreign Application Priority Data
Apr. 30, 2013 (KR) 10-2013-0048379

(51) Int. Cl. H02J 17/00; G08C 23/06; H04B 10/80; H01F 38/14

(52) U.S. Cl. CPC H02J 17/00; H01F 38/14; G08C 23/06; H04B 10/807
USPC 340/870.28; 307/149; 307/104

(57) ABSTRACT

There is provided a system and method for supplying power to a transmission tower using an optical power transmission device including a transmission line, an optical power transmission device which is mounted on the transmission line and converts power obtained in the transmission line into an optical signal, a transmission tower, an optical power reception device which is mounted on the transmission tower and converts the optical signal into an electrical signal to supply power to various devices mounted on the transmission tower, and an optical fiber which has one end connected to the optical power transmission device and another end connected to the optical power reception device and transmits the optical signal of the optical power transmission device to the optical power reception device, wherein the optical fiber is insulated with an insulator string.

### BACKGROUND OF THE INVENTION

1. Technical Field

The present invention relates to a system and method for supplying power to a transmission tower and a method for transmitting and receiving data using the optical power transmission device.

Especially, the present invention relates to a system and method for supplying power to a transmission tower in which power is supplied to various devices mounted on the transmission tower, wherein the system and method includes an optical power transmission device which is mounted on a transmission line in a non-contact manner, an optical cable which has a jacket formed with an insulator string and is used to transmit an optical signal outputted from the optical power transmission device to an optical power reception device mounted on the transmission tower, and an optical, power reception device which receives the optical signal from the optical cable, and then converts the received optical signal into electricity.

2. Description of the Related Art

Various monitoring devices such as a transmission tower monitoring device, a fault location diagnosing device, a lightning monitoring device, etc. as well as a variety of devices such as an aviation obstacle lamp, a communication device, etc. are mounted on a transmission tower and used in various purposes. The above-mentioned various devices mounted on the transmission tower are operated after being supplied with an external power. To supply power to devices mounted on most transmission towers, a solar photovoltaic module, a rechargeable battery, or an electromagnetic induction type self-power supply device which is connected to the various devices is recently used. When power is supplied using the solar photovoltaic module, the solar photovoltaic module has a problem that stops generating electricity in a rainy season, foggy weather, a monsoon season, a snow season, etc., so as to fail to supply power to the various devices mounted on the transmission tower, and a battery, which is recharged with power generated from the solar photovoltaic module, also has the same problem. In addition, the transmission line monitoring device and the communication device mounted on a transmission line itself may be operated after being supplied with power generated in an electromagnetic induction method from the transmission line. Accordingly, in order to supply the power obtained in an electromagnetic induction method from the transmission line to the transmission tower on which the devices are mounted or to the ground, a power cable has to be connected. In this case, an insulation breakdown or a short circuit occurs due to an extra high voltage electric field of an overhead transmission line, so that it is problematic that reliability and safety fails to be secured.

Korean patent number 10-0337029 registered on May 4, 2002, entitled “Aviation Obstacle Lamp Apparatus Using an Inductive Power from a Transmission line” is registered.

According to the above-mentioned patent, a configuration including a means which is mounted on a transmission line to detect inductive power and an insulated extension cable which supplies the detected inductive power to an aviation obstacle lamp mounted on a transmission tower is disclosed.

However, as described above, the means for detecting inductive power of the transmission line and the insulated extension cable connecting to the aviation obstacle lamp mounted on the transmission tower have a problem, that fails to secure reliability and safety due to an insulation breakdown or a short circuit.

Accordingly, it is needed to develop a system and method for supplying power to a transmission tower using an optical power transmission device in which power obtained in a non-contact electromagnetic induction manner from a current flowing in a transmission line is transmitted to a transmission tower through an optical cable transmission method and an insulation method of the optical cable, so that an insulation breakdown or a shot circuit of a connecting cable is removed and reliability as well as safety are high. In addition, a system and method which further includes a system and method for transmitting communication data using the optical power transmission device is needed to be developed.

### SUMMARY OF THE INVENTION

A task of the present invention is applied to solve the defects of the prior art, and is to provide a system and method for supplying power to a transmission tower using an optical power transmission device which is mounted on a transmission line to transmit power obtained in an electromagnetic induction manner to a transmission tower, wherein the obtained power is transmitted to the transmission tower through an insulated optical fiber after being converted into an optical signal, and then an optical power reception device mounted on the transmission tower converts the optical signal into an electrical signal to supply the converted power to various devices, so that an insulation breakdown or a short circuit of a connecting cable is removed.

In addition, another task of the present invention is to provide a communication system, and method using the optical power transmission device.

In order to solve the above-mentioned task, according to a first aspect of the present invention, there is provided a system for supplying power to a transmission tower using an optical power transmission device including an optical power transmission device which is mounted on a transmission line in a non-contact manner to generate power in an electromagnetic induction manner, and then convert an electrical signal into an optical signal, an optical power reception device which is mounted on the transmission tower to convert the optical signal transmitted from the optical power transmission device into an electrical signal, and a determined length of an optical fiber which is used to transmit the optical signal from the optical power transmission device to the optical power reception device, wherein the optical fiber is disposed in a determined length of an insulator having one end fixed to the transmission line and another end fixed to the transmission tower.

In addition, according to a second aspect of the present invention, there is provided a system for supplying power to a transmission tower using an optical power transmission device further including an optical transmitter and receiver module of a data transmitter and receiver which is supplied with power from the optical power reception device to convert a variety of collected monitoring data into an optical signal, and then transmit the converted optical signal, an optical transmitter and receiver module of a data transmitter and receiver which is supplied with power from the optical power transmission device to receive the optical signal transmitted from the optical transmitter and receiver module of the optical power reception device, and then convert the received optical signal into monitoring data, and an optical fiber which is insulated with an insulator string and mounted in the insulator to receive the optical signal, from the optical transmitter and receiver module in the data transmitter and receiver of the optical power reception device, and then transmit the received optical signal to the optical transmitter and receiver module in the data transmitter and receiver of the optical power transmission device.

Furthermore, according to a third aspect of the present invention, there is provided a method for supplying power to a transmission tower using an optical power transmission device including, at an electromagnetic induction power generating means mounted on a transmission line in a non-contact manner, generating electrical power, at a non-contact power supply, receiving alternating current (AC) power generated from the electromagnetic induction power generating means, and then converting the received AC power into direct current (DC) power, at an optical power transmitter, converting the DC power into a continuous wave laser signal to couple the converted signal into an optical fiber, and, at an optical power receiver mounted on a transmission tower, receiving the continuous wave laser signal transmitted through the optical fiber, and then converting the received signal into an electrical signal after amplification to transmit power to a power supply device.

Moreover, according to a fourth aspect of the present invention, there is provided a method for supplying power to a transmission tower using an optical power transmission device including, at an optical power reception device mounted on a transmission tower, receiving power transmitted from, an optical power transmission device mounted on a transmission line, and then supplying the received power to various monitoring systems mounted on the transmission tower, at the monitoring systems, transmitting various monitoring data to an optical transmitter and receiver module of a data transmitter and receiver, at the optical transmitter and receiver module, coupling the transmitted monitoring data into an optical fiber, at an optical transmitter and receiver module of a data transmitter and receiver included in the optical power transmission device mounted on the transmission line, receiving the monitoring data transmitted through the optical fiber, and, at the optical transmitter and receiver module, transmitting the received monitoring data to a communication device through a controller.

### BRIEF DESCRIPTION OF DRAWINGS

FIG. 1 illustrates a configuration of a system for supplying power to a transmission tower using an optical power transmission device according to an embodiment of the present, invention in a schematic view.

FIG. 2 illustrates a configuration of an essential portion of a system for supplying power to a transmission tower using an optical power transmission device according to an embodiment of the present invention in a schematic view.

FIG. 3 illustrates a configuration of a system for supplying power to a transmission tower using an optical power transmission device according to another embodiment of the present invention in a schematic view.

FIG. 4 is a flow chart of a method for supplying power to a transmission tower using an optical power transmission device according to an embodiment of the present invention.

FIG. 5 is a flow chart of a method for transmitting and receiving data using an optical power transmission device according to an embodiment of the present invention.

FIG. 6 is a flow chart of a method for transmitting and receiving data using an optical power transmission device according to another embodiment of the present invention.

### DESCRIPTION OF THE PREFERRED EMBODIMENTS

Hereinafter, configurations of embodiments of the present invention are described in detail with reference to the accompanying drawings.

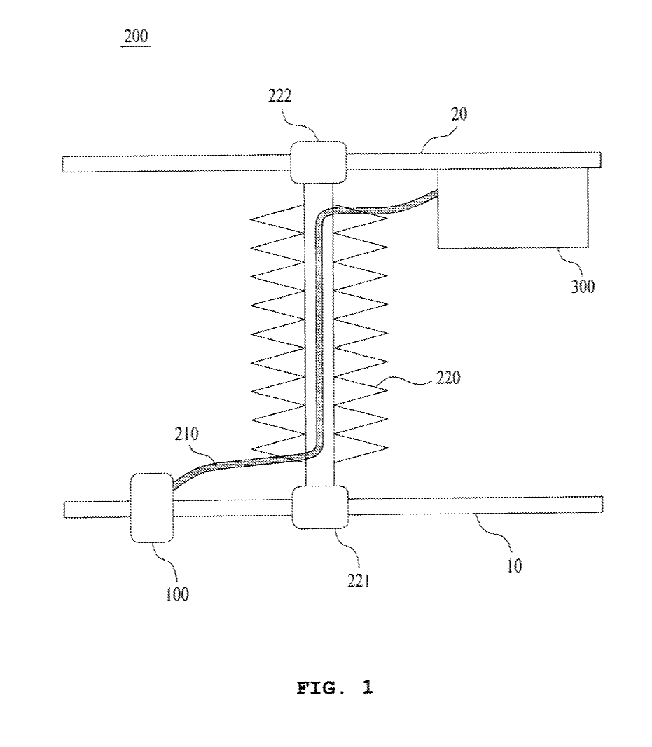

FIG. 1 illustrates a configuration of a system for supplying power to a transmission tower using an optical power transmission device according to an embodiment of the present invention in a schematic, view. As shown in FIG. 1, the system for supplying power to a transmission tower using an optical power transmission device of the present invention includes an optical power transmission device 100 which is mounted on a transmission line 10 in a non-contact manner to obtain power in an electromagnetic induction manner, and then convert an electrical signal into an optical signal, an optical power reception device 300 which is mounted on a transmission tower 20 or the ground to convert the optical signal transmitted from the optical power transmission device 100 into an electrical signal, and a determined length of an optical fiber 210 which is used to transmit the optical signal from the optical power transmission device 100 to the optical power reception device 300, wherein the optical fiber 210 is disposed in a determined length of an insulator 220 having one end fixed to the transmission line 10 and another end fixed to the transmission tower 20.

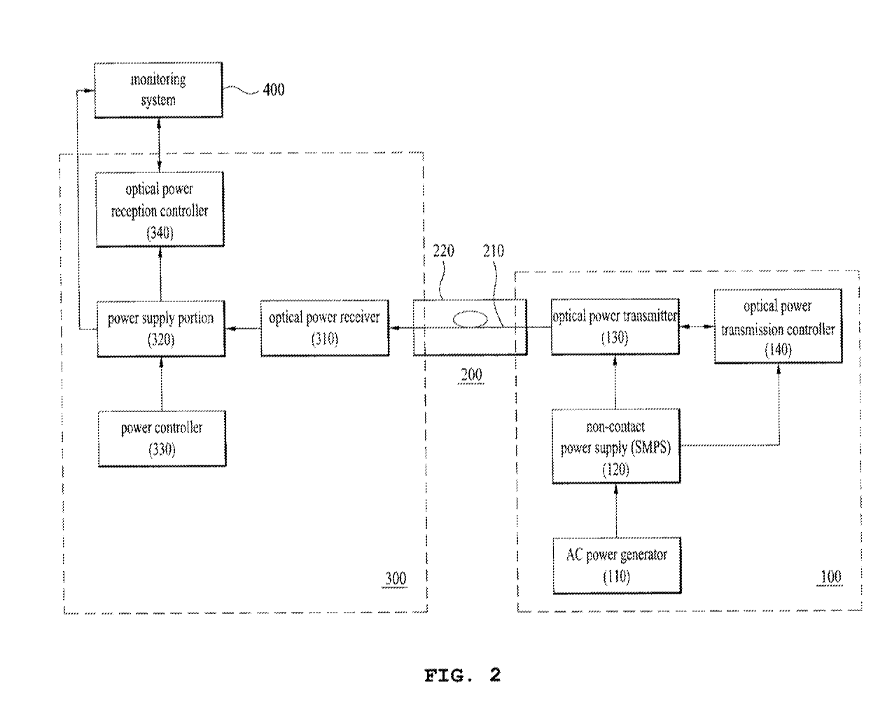

FIG. 2 illustrates a configuration of an essential portion of a system for supplying power to a transmission tower using an optical power transmission device according to an embodiment of the present invention in a schematic view. As shown in FIG. 2, the system for supplying power to a transmission tower using an optical power transmission device of the present, invention is configured to include an optical power transmission device 100 consisting of an AC power generator 110 which generates power in an electromagnetic induction manner, a non-contact power supply 120 which is supplied with the AC power generated from the AC power-generator 110, and then converts the supplied AC power into DC power, an optical power transmitter 130 which is supplied with the DC power from the non-contact power supply 120, and then converts the supplied DC power into a continuous wave laser signal, and an optical power transmission controller 140 which controls the optical power transmitter 130 that is operated after being supplied with the DC power from the non-contact power supply 120; an optical power transmission portion 200 consisting of a determined length of an optical fiber 210 into which the continuous wave laser signal transmitted from the optical power transmitter 130 is coupled, and a determined length of an insulator 220 which accommodates the optical fiber 210 inside; and an optical power reception device 300 consisting of an optical power receiver 310 which converts the continuous wave laser signal coupled from the optical power transmitter 130 into an electrical signal, a power supply portion 320 which receives the electrical signal converted in the optical power receiver 310 to supply the received signal to various monitoring systems, a power controller 330 which controls a power supply of the power supply portion 320, and an optical power reception controller 340 which is supplied with power from the power supply portion 320 and controls the optical power receiver 310 as well as the various monitoring systems 400.

The AC power generator 110 is configured to generate AC power from the transmission line through an electromagnetic induction manner, wherein an output current remains constant rather than increasing in proportion to a current of a primary power line of the transmission line. The AC power generator 110 interposes an insulator between a transmission line and a magnetic core, so as to foe configured in a non-contact manner. Under the condition that a structure of the AC power generator 110 has an external diameter of 160 mm and a width of 200 mm, a secondary load power of 60 W may be obtained when a current of 50 to 1,000 A flows in the primary transmission line.

The non-contact power supply 120 converts AC power supplied from the AC power generator 110 into DC power through a rectifier circuit, etc. In order to transmit the DC power to the transmission tower, the optical power transmitter 130 converts the DC power into a continuous wave (CW) laser signal of 850 to 1,550 nm through a high power diode, and then couples the converted signal into the optical fiber 210 of the optical power transmission portion 200. The optical power receiver 310 receives the continuous wave laser signal from the optical fiber 210, and then converts the received optical signal into an electrical signal. The power supply portion 320 receives the electrical signal, which is converted by the optical power receiver 310, and then supplies power to the various monitoring systems 400.

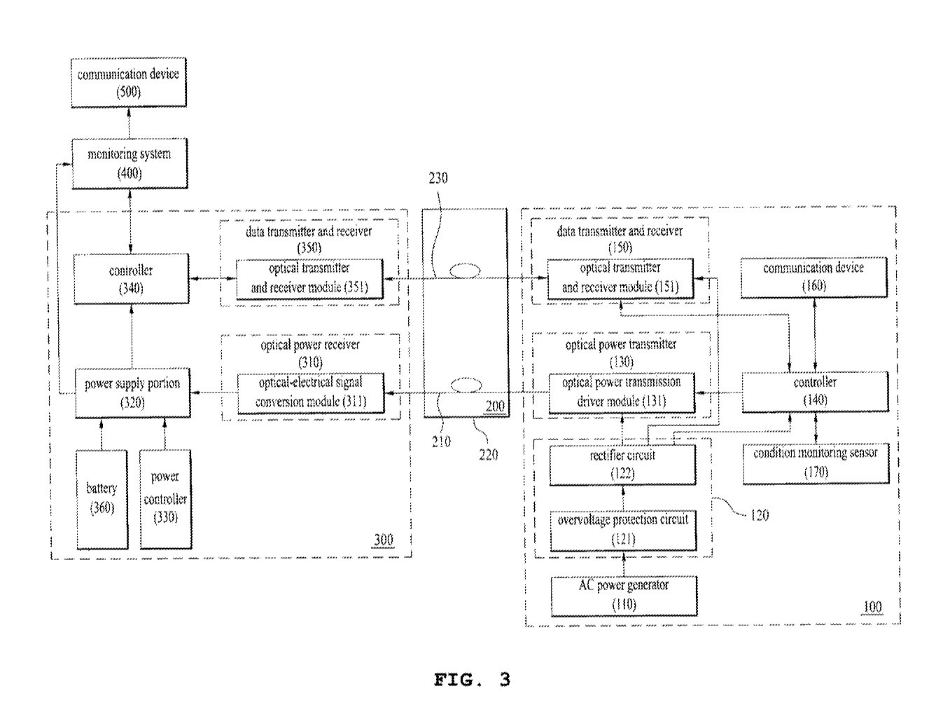

FIG. 3 illustrates a configuration of a system for supplying power to a transmission tower using an optical power transmission device according to another embodiment of the present invention in a schematic view. As shown in FIG. 3, the system for supplying power to a transmission tower using an optical power transmission device of the present invention is configured to include an optical power transmission device 100 consisting of an AC power generator 110 which generates AC power in an electromagnetic induction manner, a non-contact power supply 120 which has an overvoltage protection circuit 121 for protecting the non-contact power supply against over voltage generated from the AC power generator 110 and a rectifier circuit 122 for converting the AC power into DC power, an optical power transmitter 130 which has an optical power transmission driver module 231 for receiving the DC power from the non-contact power supply 120 to convert the received DC power into a continuous wave laser signal, and then couple the converted laser signal into an optical fiber, a controller 140 which controls the optical power transmitter 130 that is operated after being supplied with the DC power from the non-contact power supply 120, a condition monitoring sensor 170 which monitors a transmission line and the optical power transmission device to generate monitoring data, a data transmitter and receiver 150 which has an optical transmitter and receiver module 151 for receiving the monitoring data from the condition monitoring sensor 170, and then converting the received monitoring data into an optical signal to transmit the monitoring data to an optical power reception device 300 or receiving monitoring data transmitted from a monitoring system 400 mounted on the transmission tower, a controller 140 which processes the monitoring data transmitted from the optical transmitter and receiver module 151 or measurement data collected from the condition monitoring sensor 170, and a communication device 160 which transmits the data processed in the controller 140 to an external superordinate network; an optical signal transmission portion 200 consisting of a determined length of an optical fiber 210 which is used to transmit the continuous wave laser signal coupled from the optical power transmission driver module 131 of the optical power transmission device 100, an optical fiber 230 which is used to transmit the monitoring data transmitted from the monitoring system 400 mounted on the transmission tower to the optical transmitter and receiver module 151 in the data transmitter and receiver of the optical power transmission device 100, and a determined length of an insulator 220 which accommodates the optical fibers 210 and 230 inside; and an optical power reception device 300 consisting of an optical power receiver 310 which has an optical-electrical signal conversion module 311 for converting the continuous wave laser-signal coupled from the optical signal transmission portion 200 into an electrical signal, a power supply portion 320 which receives the electrical signal converted in the optical power receiver 310 to supply the received signal to the various monitoring systems 400, a power controller 330 which controls a power supply of the power supply portion 320, a data transmitter and receiver 350 which has an optical transmitter and receiver module 351 for converting the monitoring data transmitted from the monitoring system 400 into an optical signal to couple the converted optical signal into the optical fiber 230, or converting an optical signal transmitted from the optical power transmission device 100 through the optical fiber 230 into monitoring data to transmit the converted monitoring data, and a controller 340 which is supplied with power from the power supply portion 320 and controls the optical power receiver 310 as well as the various monitoring systems 400.

In addition, a communication device 500 for receiving the monitoring data from the monitoring system 400, and then transmitting the received monitoring data may be further included. Furthermore, a backup battery 360 connected to the power supply portion 320 may be further included.

The optical fiber 210 for transmitting an optical signal coupled from the optical power transmission driver module 131 of the optical power transmission device 100 to the optical-electrical signal conversion module 311 in the optical power receiver 310 of the optical power reception device 300 may be configured as unidirectional, while the another optical fiber 230 for transmitting an optical signal of monitoring data from the optical transmitter and receiver module 351 in the data transmitter and receiver 35G of the optical power reception device 300 to the optical transmitter and receiver module 151 in the data transmitter and receiver 150 of the optical power transmission device 100 may be configured as bidirectional. The condition monitoring sensor 170 of the optical power transmission device 100 may include various sensors such as a current measurement sensor, a temperature sensor, a sag sensor, and a video camera. Also, the communication device 160 may include a wireless communication module and transmit data in the condition monitoring sensor 170 as well as monitoring data transmitted from the optical power reception device 300 from the wireless communication module to an external superordinate network through the controller 140. Besides, the monitoring system 400 mounted on the transmission tower may include a fault diagnosing device, a lightning monitoring device, em aviation obstacle lamp device, a transmission tower monitoring device, other communication devices, etc.

The AC power generator 110 mounted on the transmission line in a non-contact manner obtains AC power through an electromagnetic induction power generating method, and then the rectifier circuit 122 converts the AC power into DC power after the AC power passes through the overvoltage protection circuit 121 of the non-contact power supply 120. The DC power converted in the non-contact power supply 120 is supplied to the optical, power transmission driver module 131. For power transmission, the DC power is converted into a continuous wave laser signal of 850 to 1,550 nm in the optical power transmission driver module 131 through a high power diode, and then coupled into the single-mode or multi-mode optical fiber 210. The optical-electrical signal conversion module 311 of the optical power reception device 300 receives the continuous wave laser signal transmitted through the optical fiber 210, and then converts the received optical laser signal into an electrical signal after amplification. The electrical signal converted in the optical-electrical signal conversion module 311 is transmitted to the power supply portion 320, and the power supply portion supplies the power to various monitoring devices or the monitoring system 400 according to a control of the power controller 330. Besides, the power may be supplied to the backup battery 360 so that the battery is recharged. The power that the optical power reception device 300 receives, for example, has a DC voltage of 33 to 5V and a current of 1 to 3 A, that is, reaches approximately 10 W, so that power more than 5 W, which is minimum dissipation power required in the monitoring system, can be supplied. Accordingly, because the optical power reception device 300 has to receive high power, a light receiving element with a high critical point is used. In addition, for optical power transmission, the multi-mode optical fiber may be configured to use one core as a parallel channel, and besides, the single-mode optical fiber may be used. Preferably, the optical fiber is longer than a minimum length of an insulator string used for a line of a transmission tower so that an insulation distance on an extra-high voltage overhead transmission line is secured.

Also, various monitoring devices of the monitoring system 400 are operated after being supplied with power from the power supply portion 320, and controls the data transmitter and receiver. In addition, the monitoring data obtained in the monitoring system 400 can be transmitted to an external network through the communication device 500. Furthermore, the controller 140 processes sense data obtained from various sensors in the condition monitoring sensor 170 of the optical power transmission device 100, and then transmits the processed data to the communication device, and the communication device 160 can transmit the transmitted data to an external network.

As described above, according to the present, invention, Ac power generated from a transmission line in an electromagnetic induction power generating mariner is converted into DC power, and then the converted DC power is transmitted through an optical fiber which is connected between a transmission tower and the transmission line, has a jacket insulated with an insulator, and is free from an insulation breakdown, so that the transmitted power can be reliably and safely supplied to a monitoring system, etc. mounted on the transmission tower.

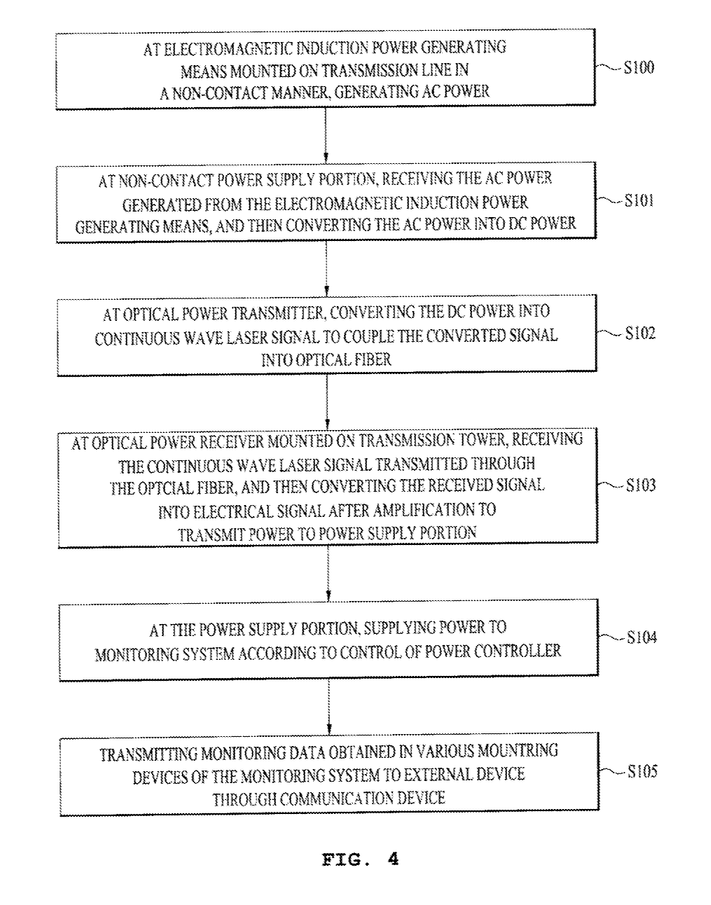

FIG. 4 is a flow chart of a method for supplying power to a transmission tower using an optical power transmission device according to an embodiment of the present, invention. As shown in FIG. 4, the method for supplying power to a transmission tower using an optical power transmission device of the present, invention is configured to include, at an electromagnetic induction power generating means mounted on a transmission line in a non-contact manner, generating electrical power (S100), at a non-contact power supply, receiving the AC power generated from the electromagnetic induction power generating means and converting the received AC power into DC power (S101), at an optical power transmitter, converting the DC power into a continuous wave laser signal to couple the converted signal into an optical fiber (S102), and, at an optical power receiver mounted on a transmission tower, receiving the continuous wave laser signal transmitted through the optical fiber, and then converting the received signal into an electrical signal after amplification to transmit power to a power supply portion (S103).

In addition, the method may further include, at the power supply portion, supplying the power to a monitoring system according to a control of a power controller (S104), and transmitting monitoring data obtained in various monitoring devices of the monitoring system to an external device through a communication device (S105).

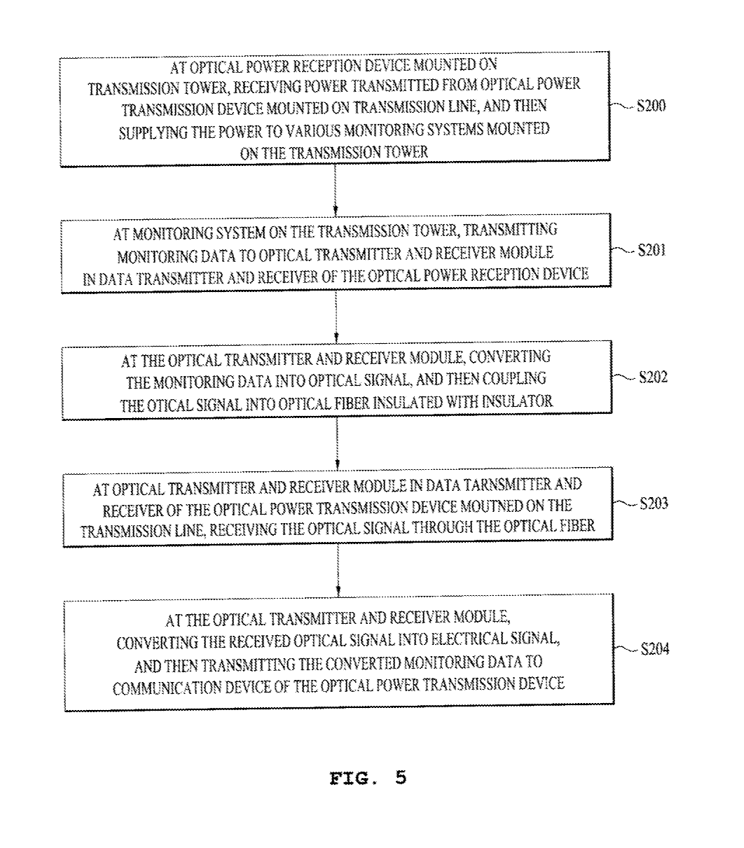

FIG. 5 is a flow chart of a method for transmitting and receiving data using an optical power transmission device according to an embodiment of the present invention. As shown in FIG. 5, the method for transmitting and receiving data using an optical power transmission device of the present invention is configured to include, at an optical power reception device mounted on a transmission tower, receiving power transmitted from an optical power transmission device mounted on a transmission line, and then supplying the received power to various monitoring systems mounted on the transmission tower (S200), at the monitoring systems on the transmission tower, transmitting monitoring data to an optical transmitter and receiver module in a data transmitter and receiver of the optical power reception device (S201), at the optical transmitter and receiver module in the data transmitter and receiver of the optical power reception device, converting the monitoring data into an optical signal, and then coupling the converted optical signal into an optical fiber insulated with an insulator (S202), at an optical transmitter and receiver module in a data transmitter and receiver of the optical power transmission device mounted on the transmission line, receiving the optical signal transmitted through the optical fiber (S203), and, at the optical transmitter and receiver module in the data transmitter and receiver of the optical power transmission device, converting the received optical signal and transmitting the monitoring data to a communication device through a controller of the optical power transmission device (S204).

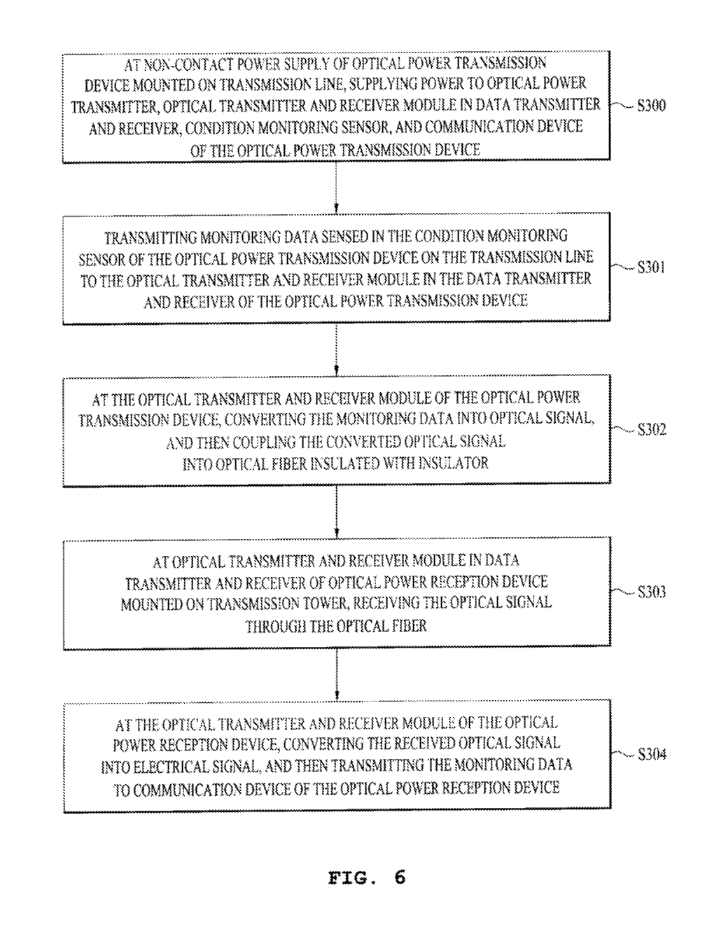

FIG. 6 is a flow chart of a method for transmitting and receiving data using an optical power transmission device according to another embodiment of the present invention. As shown in FIG. 6, the method for transmitting and receiving data using an optical power transmission device of the present invention is configured to include, at a non-contact power supply of an optical power transmission device mounted on a transmission line, supplying power to an optical power transmitter, an optical transmitter and receiver module in a data transmitter and receiver, a condition monitoring sensor, and a communication device of the optical power transmission device (S300), transmitting monitoring data sensed in the condition monitoring sensor of the optical power transmission device on the transmission line to the optical transmitter and receiver module in the data transmitter and receiver of the optical power transmission device (S301), at the optical transmitter and receiver module in the data transmitter and receiver of the optical power transmission device, converting an electrical signal of the monitoring data into an optical signal, and then coupling the converted optical signal into an optical fiber insulated with an insulator (S302), at an optical transmitter and receiver module in a data transmitter and receiver of an optical power reception device mounted on the transmission tower, receiving the optical signal through the optical fiber (S303), and, at the optical transmitter and receiver module in the data transmitter and receiver of the optical power reception device, converting the received optical signal, and then transmitting the monitoring data to a communication device of the optical power reception device (S304).

According to the present invention, a system for supplying power to a transmission tower using an optical power transmission device which is mounted on a transmission line to transmit power obtained in an electromagnetic induction manner to a transmission tower has an effect that the obtained power is converted into an optical signal to be transmitted to the transmission tower through an optical fiber insulated with an insulator, and then an optical power reception device mounted on the transmission tower converts the optical signal into an electrical signal to supply the converted power to various devices, so that the power can be transmitted to the transmission tower in a highly reliable and safe state without an insulation breakdown or a short circuit of a connecting cable. In addition, the present invention has another effect that a variety of sense data sensed in the transmission tower can be transmitted with high reliability and safety using the optical power transmission device.

The above-described embodiments of the present invention are merely a part of various embodiments of the present invention. It is apparent that various embodiments included in technical ideas of the present invention in which AC power obtained in an AC power generator mounted on a transmission line of the present invention through an electromagnetic induction power generating method is converted into DC power, an optical power transmitter converts the DC power into an optical laser signal to transmit, the converted optical laser signal to an optical power receiver through a determined length of an optical fiber insulated with an insulator, and the optical power receiver converts the optical laser signal into an electrical signal to transmit the converted electrical signal to a power supply portion are within the scope of protection of the present invention.

What is claimed is:

1. System for supplying power to a transmission tower using an optical power transmission device, comprising:
a transmission line;
an optical power transmission device which is mounted on the transmission line and converts power obtained in the transmission line into an optical signal;
a transmission tower;
an optical power reception device which is mounted on the transmission tower and converts the optical signal into an electrical signal to supply power to various devices mounted on the transmission tower; and
an optical fiber which has one end connected to the optical power transmission device and another end connected to the optical power reception device, and transmits the optical signal of the optical power transmission device to the optical power reception device,
wherein the optical fiber is insulated with an insulator string.

2. System for supplying power to a transmission fewer using an optical power transmission device according to claim 1, wherein the optical power transmission device comprises an AC power generator which generates AC power from the transmission line in an electromagnetic induction power generating manner, a non-contact power supply which receives the AC power from the AC power generator, and then converts the received AC power into DC power, and an optical power transmitter which receives the DC power from non-contact power supply, and then converts the received DC power into an optical signal to transmit the converted optical signal to the optical power reception device.

3. System for supplying power to a transmission tower using an optical power transmission device according to claim 2, wherein the non-contact power supply comprises an overvoltage protection circuit which protects the received AC power against overvoltage, and a rectifier circuit which converts the AC power into DC power.

4. System for supplying power to a transmission tower using an optical power transmission device according to claim 1, wherein the optical power reception device comprises an optical power receiver which converts an optical signal into an electrical signal, and a power supply portion which receives the electrical signal from the optical power receiver to supply power to various devices.

5. System for supplying power to a transmission tower using an optical power transmission device according to claim 4, wherein the optical power receiver comprises an optical-electrical signal conversion portion which converts an optical signal into an electrical signal.

6. System for supplying power to a transmission tower using an optical power transmission device according to claim 1, wherein the optical fiber of an optical power transmission portion is a single-mode or a multi-mode optical fiber.

7. System for supplying power to a transmission tower using an optical power transmission device according to claim 4, wherein the various devices are a transmission tower monitoring device, a fault location diagnosing device, a lightning monitoring device, and an aviation obstacle lamp device.

8. System for supplying power to a transmission tower using an optical power transmission device according to claim 1, wherein the optical power reception device further comprises a battery.

9. System for supplying power to a transmission tower using an optical power transmission device according to claim 1, wherein the optical power transmission device comprises a current measurement sensor, a temperature sensor, a sag sensor, a wind direction sensor, a wind speed sensor, and a video camera.

10. System for supplying power to a transmission tower using an optical power transmission device according to claim 1, wherein the optical power transmission device and the optical power reception device comprise communication devices which transmit monitoring data or sense data to an external device through wireless communication, respectively.

11. System for supplying power to a transmission tower using an optical power transmission device according to claim 1, wherein the system comprises optical transmitter and receiver modules which transmit and receive a variety of data between the optical power transmission device and the optical power reception device, and an optical fiber which is used to transmit data between the optical transmitter and receiver modules and has a jacket formed with an insulator.

12. System for supplying power to a transmission tower using an optical power transmission device according to claim 1, wherein the optical power transmission device further comprises a controller for controlling power transmission, and the optical power reception device further comprises a power controller for controlling power supply.

13. Method for supplying power to a transmission tower using an optical power transmission device, comprising:
at an electromagnetic induction power generating means mounted on a transmission line in a non-contact manner, generating AC power;
at a non-contact power supply, receiving the AC power generated from the electromagnetic induction power generating means, and then converting the received AC power into DC power;
at an optical power transmitter, converting the DC power into a continuous wave laser signal to couple the converted signal into an optical fiber; and
at an optical power receiver mounted on a transmission tower, receiving the continuous wave laser signal transmitted through the optical fiber, and then converting the received signal into an electrical signal after amplification to transmit power to a power supply portion.

14. Method for supplying power to a transmission tower using an optical power transmission device according to claim 13, wherein the method further comprises, at the power supply portion, supplying power to a monitoring system according to a control of a power controller, and transmitting monitoring data obtained in various monitoring devices of the monitoring system to an external device through a communication device.

15. Method for transmitting and receiving data using an optical power transmission device, comprising:
after power generated from an optical power transmission device mounted on a transmission line is converted into an optical signal, and then transmitted through an optical fiber, at an optical power reception device mounted on a transmission tower, receiving the optical signal to convert the optical signal into power, and then supplying the power to various monitoring systems mounted on a transmission tower;
at the monitoring systems on the transmission tower, transmitting monitoring data to an optical transmitter and receiver module in a data transmitter and receiver of the optical power reception device;
at the optical transmitter and receiver module in the data transmitter and receiver of the optical power reception device, converting the monitoring data into an optical signal, and then coupling the converted optical signal into an optical fiber insulated with an insulator string;
at an optical transmitter and receiver module in a data transmitter and receiver of the optical power transmission device mounted on the transmission line, receiving the optical signal transmitted through the optical fiber; and
at the optical transmitter and receiver module in the data transmitter and receiver of the optical power transmission device, converting the received optical signal, and then transmitting the monitoring data to a communication device of the optical power transmission device.

16. Method for transmitting and receiving data using an optical power transmission device, comprising:
at a non-contact power supply of an optical power transmission device mounted on a transmission line, supplying power to an optical power transmitter, an optical transmitter and receiver module in a data transmitter and receiver, a controller, a condition monitoring sensor, and a communication device of the optical power transmission device;
transmitting monitoring data sensed in the condition monitoring sensor of the optical power transmission device on the transmission line to the optical transmitter and receiver module in the data transmitter and receiver of the optical power transmission device;
at the optical transmitter and receiver module in the data transmitter and receiver of the optical power transmission device, converting the monitoring data into an optical signal, and then coupling the converted optical signal into an optical fiber insulated with an insulator string;
at an optical transmitter and receiver module in a data transmitter and receiver of an optical power reception device mounted on a transmission tower, receiving the optical signal through the optical fiber; and
at the optical transmitter and receiver module in the data transmitter and receiver of the optical power reception device, converting the received optical signal, and then transmitting the monitoring data to a communication device of the optical power reception device.

17. Method for transmitting and receiving data using an optical power transmission device, comprising:
at a non-contact power supply of an optical power transmission device mounted on a transmission line, supplying power to an optical power transmitter, an optical transmitter and receiver module in a data transmitter and receiver, a controller, a condition monitoring sensor, and a communication device of the optical power transmission device;
at the condition monitoring sensor of the optical power transmission device on the transmission line, sensing monitoring data; and
transmitting the sensed monitoring data to a communication device.
